(19) United States
(12) Patent Application Publication
(10) Pub. No.: US 2014/0304453 A1
(43) Pub. Date: Oct. 9, 2014

(54) Effective Caching for Demand-based Flash Translation Layers in Large-Scale Flash Memory Storage Systems

(71) Applicant: THE HONG KONG POLYTECHNIC UNIVERSITY, Hong Kong (HK)

(72) Inventors: Zili SHAO, Hong Kong (HK); Zhiwei QIN, Hong Kong (HK); Yi WANG, Hong Kong (HK); Renhai CHEN, Hong Kong (HK); Duo LIU, Hong Kong (HK)

(73) Assignee: The Hong Kong Polytechnic University, Hong Kong (HK)

(21) Appl. No.: 13/858,105

(22) Filed: Apr. 8, 2013

(51) Int. Cl. G06F 12/02

(52) U.S. Cl. CPC G06F 12/0246
USPC 711/103

(57) ABSTRACT

This invention discloses methods for implementing a flash translation layer in a computer subsystem comprising a flash memory and a random access memory (RAM). According to one disclosed method, the flash memory comprises data blocks for storing real data and translation blocks for storing address-mapping information. The RAM includes a cache space allocation table and a translation page mapping table. The cache space allocation table may be partitioned into a first cache space and a second cache space. Upon receiving an address-translating request, the cache space allocation table is searched to identify if an address-mapping data structure that matches the request is present. If not, the translation blocks are searched for the matched address-mapping data structure, where the physical page addresses for accessing the translation blocks are provided by the translation page mapping table. The matched address-translating data structure is also used to update the cache space allocation table.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to an on-demand address mapping scheme for flash memories. In particular, this invention relates to demand-based block-level address mapping schemes with caches for use in large-scale flash storage systems to reduce the RAM footprint.

### BACKGROUND

A NAND flash memory is widely used as a non-volatile, shock resistant, and low power-consumption storage device. Similar to other storage media, the capacity of flash-memory chips is increasing dramatically and doubled about every two years. The increasing capacity of NAND flash memory poses tremendous challenges for vendors in the design of block-device emulation software in flash management. In particular, the cost of main-memory (RAM) must be under control on the premise of maintaining good system response time.

FIG. 1 depicts a typical architecture of a flash storage system. In a NAND flash storage system, a flash translation layer (FTL) 130 is a block-device-emulation layer built above the memory technology device (MTD) layer 140, where the MTD layer 140 can do primitive read, write and erase operations on flash cells of a flash memory 150. The main role of the FTL 130 is to do mapping between a logical unit address employed in a file system 120 and a corresponding physical unit address adopted in the flash memory 150.

The address mapping table, which usually resides in RAM, is used to store address mapping information. With more and more physical pages and blocks integrated in NAND flash chips, the RAM requirements are potentially increased in order to record the address mapping information. For example, given a large-block (2 KB/page) based 32 GB Micron NAND flash memory MT29F32G08CBABAWP, the mapping table size for the page level FTL scheme is 96 MB, which is too big to be kept in the RAM especially for low-end flash drives.

To address this problem, a block-level address mapping scheme has been proposed and is popularly adopted for NAND flash storage systems. With block-to-block address mapping, such an FTL can significantly reduce the address mapping table size when compared with an FTL that employs the fine-grained page-level mapping. However, with an increase in the flash-memory capacity, a RAM of a greater size is required to store the mapping table. For example, for the above-mentioned 32 GB Micron NAND flash memory, the block-level address mapping table may take up 1.13 MB of the RAM space. The problem becomes more serious as the capacity of NAND flash memory increases. The present invention is concerned with solving the aforementioned problem by using an on-demand mapping strategy for large scale NAND flash storage systems.

The present invention is related to a demand-based flash translation layer (DFTL). An overview on the DFTL is given by Gupta, A., Kim, Y., and Urganokar, B. (2009), “DFTL: a flash translation layer employing demand-based selective caching of page-level address mapping,” Proceedings of the 14^{th} International Conference on Architectural Support for Programming Languages and Operating Systems (ASPLOS'09), pp. 229-240, Mar. 7-11, 2009, the disclosure of which is incorporated by reference herein. The DFTL is the first on-demand page-level mapping scheme. Instead of using a traditional approach of storing a page-level address mapping table in the RAM, the DFTL stores the address mapping table in specific flash pages. In the RAM, one cache is designed to store the address mappings frequently used by the file system. Another global translation directory (GTD) is maintained in the RAM permanently as the entries towards the translation pages. Therefore, the DFTL can effectively reduce the RAM footprint. Despite this, the DFTL is based on the page-level address-mapping scheme and the reduction in the RAM footprint is not as significant as against the block-level address-mapping strategy. Moreover, the page-level mapping table still occupies a lot of space in the flash memory for the DFTL. The presence of this mapping table not only takes up extra space in the flash memory but also introduces more overhead in time and endurance in order to manage it when compared to block-level address-mapping schemes, which usually require address-mapping tables that are much smaller.

There is a need in the art for an improved DFTL with less RAM footprint over existing DFTL.

### SUMMARY OF THE INVENTION

The present invention provides a first method and a second method for implementing an FTL in a computer subsystem that comprises a flash memory and a RAM. The flash memory is arranged in blocks each of which comprises a number of pages and is addressable according to a physical block address. Each of the pages in any one of the blocks is addressable by a physical page address. The flash memory may be a NAND flash memory.

The first disclosed method comprises: allocating a first number of the blocks as data blocks for storing real data; allocating a second number of the blocks other than the data blocks as translation blocks; allocating a first part of the RAM as a cache space allocation table; allocating a second part of the RAM as a translation page mapping table; and when an address-translating request is received, translating a requested virtual data block address to a physical block address corresponding thereto by an address-translating process.

In addition, an entirety of the translation blocks is configured to store a block-level mapping table comprising first address-mapping data structures each of which includes (1) a logical block address of one of the data blocks and (2) a physical block address that corresponds to the logical block address of the one of the data blocks. The cache space allocation table is configured to comprise second address-mapping data structures each of which either is marked as available, or includes (1) a logical block address of a selected one of the data blocks and (2) a physical block address that corresponds to the logical block address of the selected one of the data blocks. The translation page mapping table is configured to comprise third address-mapping data structures each of which includes (1) a logical block address of a selected one of the data blocks, and (2) a physical page address of a translation page that stores the physical block address corresponding to the logical block address of the selected one of the data blocks.

In particular, the address-translating process is characterized as follows. The cache space allocation table is searched for identifying, if any, a first-identified data structure selected from among the second address-mapping data structures where the logical block address in the first-identified data structure matches the requested virtual data block address. If the first-identified data structure is identified, the physical block address in the first-identified data structure is assigned as the physical block address corresponding to the requested virtual data block address. If the first-identified data structure is not identified, the translation blocks are searched for identifying a second-identified data structure selected from among the first address-mapping data structures where the logical block address in the second-identified data structure matches the requested virtual data block address, wherein the translation page mapping table provides the physical page addresses stored therein for accessing the translation blocks. When the second-identified data structure is identified, perform the following: (1) assigning the physical block address in the second-identified data structure as the physical block address corresponding to the requested virtual data block address; and (2) updating the cache space allocation table with the second-identified data structure by a cache-updating process, wherein the cache-updating process includes copying the second-identified data structure onto a targeted second address-mapping data structure selected from among the second address-mapping data structures.

Preferably, a sequential search is conducted in the searching of the cache space allocation table for identifying the first-identified data structure.

Preferably, the cache space allocation table is partitioned into a third number of cache spaces. If the cache space allocation table is full, one of the cache spaces is selected as a first chosen cache space. Then one of the second address-mapping data structures in the first chosen cache space is selected as the targeted second address-mapping data structure for the second-identified data structure to be copied onto. All the second address-mapping data structures in the first chosen cache space except the targeted second address-mapping data structure are also marked as available. If the cache space allocation table is not full, one of the second address-mapping data structures marked as available is selected as the targeted second address-mapping data structure.

The third number for partitioning the cache space allocation table may be two so that the cache space allocation table is partitioned into a first cache space and a second cache space. Consider a situation that the cache space allocation table is full. If the first cache space is designated for storing random mapping items, the first cache space is selected to be the first chosen cache space. Otherwise, the second cache space is selected to be the first chosen cache space. Consider another situation that the cache space allocation table is not full. A second chosen cache space, which is either the first cache space or the second cache space, is a cache space containing the targeted second address-mapping data structure. If the second chosen cache space is not designated for storing random mapping items and if the second-identified data structure is not a sequential item in the second chosen cache space, then the second chosen cache space is re-designated as a cache space for storing random mapping items.

Any one of the first address-mapping data structures may further include a replacement physical data block address corresponding to the logical block address therein while the logical block address therein is regarded as a virtual data block address and the physical block address therein is regarded as a primary physical data address. Similarly, any one of the second address-mapping data structures, if not marked as available, may further include a replacement physical data block address corresponding to the logical block address therein while the logical block address therein is regarded as a virtual data block address and the physical block address therein is regarded as a primary physical data address. It follows that the primary physical block address and the replacement physical data block address, both corresponding to the requested virtual data block address, can be obtained after the address-translating request is received.

The second disclosed method comprises: allocating a first number of the blocks as data blocks for storing real data; allocating a second number of the blocks other than the data blocks as translation blocks; allocating a first part of the RAM as a data block mapping table cache (DBMTC); allocating a second part of the RAM as a translation page mapping table (TPMT); allocating a third part of the RAM as a translation page reference locality cache (TPRLC); allocating a fourth part of the RAM as a translation page access frequency cache (TPAFC); and when an address-translating request is received, translating a requested virtual data block address to a physical block address corresponding thereto by an address-translating process.

In addition, an entirety of the translation blocks is configured to store a block-level mapping table comprising first address-mapping data structures each of which includes a logical block address of one of the data blocks and a physical block address that corresponds to the logical block address of the one of the data blocks. The DBMTC is configured to comprise second address-mapping data structures each of which either is marked as available, or includes a logical block address of a selected one of the data blocks and a physical block address that corresponds to the logical block address of the selected one of the data blocks. The TPMT is configured to comprise third address-mapping data structures each of which includes a logical block address of a selected one of the data blocks, a physical page address of a translation page that stores the physical block address corresponding to the logical block address of the selected one of the data blocks, a location indicator for indicating a positive result or a negative result on whether a copy of the aforesaid translation page is cached in the RAM, and a miss-frequency record. The TPRLC is configured to comprise fourth address-mapping data structures each of which either is marked as available, or includes a logical block address of a selected one of the data blocks and a physical block address that corresponds to the logical block address of the selected one of the data blocks. The TPAFC is configured to comprise fifth address-mapping data structures each of which either is marked as available, or includes a logical block address of a selected one of the data blocks and a physical block address that corresponds to the logical block address of the selected one of the data blocks.

In particular, the address-translating process is characterized as follows. The DBMTC is searched for identifying, if any, a first-identified data structure selected from among the second address-mapping data structures where the logical block address in the first-identified data structure matches the requested virtual data block address. If the first-identified data structure is identified, the physical block address in the first-identified data structure is assigned as the physical block address corresponding to the requested virtual data block address. If the first-identified data structure is not identified, the TPMT is searched for identifying a second-identified data structure among the third address-mapping data structures where the logical block address in the second-identified data structure matches the requested virtual data block address. If the location indicator in the second-identified data structure indicates the positive result, the TPRLC and the TPAFC are searched for a third-identified data structure selected from among the fourth and the fifth address-mapping data structures where the logical block address in the third-identified data structure matches the requested virtual data block address. If the third-identified data structure is identified in the TPAFC, the miss-frequency record in the second-identified data structure is increased by one. When the third-identified data structure is identified, the physical block address in the third-identified data structure is assigned as the physical block address corresponding to the requested virtual data block address. If the location indicator in the second-identified data structure indicates the negative result, perform the following: (1) loading an entirety of the translation page having the physical page address stored in the second-identified data structure from the flash memory to the RAM; and (2) searching the loaded translation page for identifying a fourth-identified data structure in the loaded translation page where the logical block address in the fourth-identified data structure matches the requested virtual data block address. When the fourth-identified data structure is identified, perform the following: (1) assigning the physical block address in the fourth-identified data structure as the physical block address corresponding to the requested virtual data block address; (2) updating the DBMTC with the fourth-identified data structure; (3) updating either the TPRLC or the TPAFC with the loaded translation page in its entirety by a cache-updating process; and (4) updating the location indicator in the second-identified data structure with the positive result.

Preferably, a sequential search is conducted in the searching of the TPRLC and the TPAFC for a third-identified data structure.

Optionally, the cache-updating process is characterized by the following. If any one of the TPRLC and the TPAFC is not full, store the loaded translation page into a targeted cache that is selected from the TPRLC and the TPAFC and that is not full. If both the TPRLC and the TPAFC are full, perform the following: (1) selecting a first victim translation page from the TPRLC, and retrieving the miss-frequency record in a fifth-identified data structure selected from among the third address-mapping data structures where the fifth-identified data structure has the physical page address therein matched with a physical page address of the first victim translation page; (2) selecting a second victim translation page from the TPAFC, and retrieving the miss-frequency record in a sixth-identified data structure selected from among the third address-mapping data structures where the sixth-identified data structure has the physical page address therein matched with a physical page address of the second victim translation page; (3) selecting a targeted victim translation page from the first and the second victim translation pages according to the miss-frequency records in the fifth-identified data structure and in the sixth-identified data structure; and (4) overwriting the loaded translation page onto the targeted victim translation page.

Preferably, the first victim translation page is selected from among translation pages present in the TPRLC according to Least recently used (LRU) algorithm, and the second victim translation page is selected from among translation pages present in the TPAFC according to Least frequently used (LFU) algorithm.

Any one of the first address-mapping data structures may further include a replacement physical data block address corresponding to the logical block address therein while the logical block address therein is regarded as a virtual data block address and the physical block address therein is regarded as a primary physical data address. Any one of the second, the fourth and the fifth address-mapping data structures, if not marked as available, may further include a replacement physical data block address corresponding to the logical block address therein while the logical block address therein is regarded as a virtual data block address and the physical block address therein is regarded as a primary physical data address. It follows that the primary physical block address and the replacement physical data block address, both corresponding to the requested virtual data block address, can be obtained after the address-translating request is received.

### BRIEF DESCRIPTION OF THE DRAWINGS

FIG. 1 depicts a typical architecture of a flash storage system.

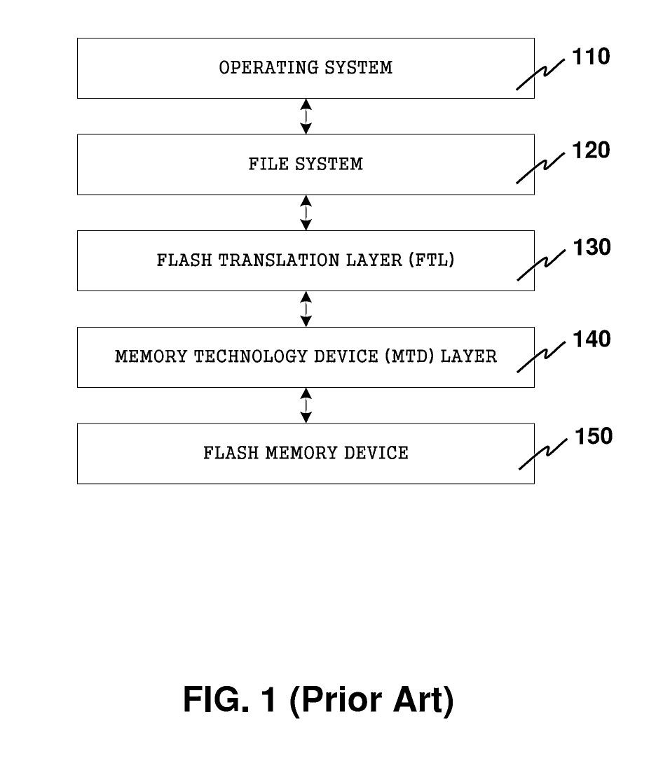

FIG. 2 is a schematic diagram depicting a demand-based address mapping scheme for a flash storage in a system having very limited RAM space in accordance with an embodiment of this invention.

FIG. 3 illustrates, in accordance with an embodiment of the present invention, a translation page mapping table as used in the system having very limited RAM space.

FIG. 4 illustrates, in accordance with an embodiment of the present invention, the mapping items in a cache space allocation table as used in the system having very limited RAM space.

FIG. 5 is a flowchart, in accordance with an embodiment of the present invention, showing address translation procedures of demand-based address mapping for the system having very limited RAM space.

FIG. 6 is a schematic diagram depicting a demand-based address mapping scheme for a flash storage in a system having limited RAM space in accordance with an embodiment of this invention.

FIG. 7 illustrates, in accordance with an embodiment of the present invention, a translation page mapping table as used in the system having limited RAM space.

FIG. 8 illustrates, in accordance with an embodiment of the present invention, the mapping items in a data block mapping table as used in the system having limited RAM space.

FIG. 9 illustrates, in accordance with an embodiment of the present invention, a translation page reference locality cache as used in the system having limited RAM space.

FIG. 10 illustrates, in accordance with an embodiment of the present invention, a translation page access frequency cache as used in the system having limited RAM space.

FIG. 11 is a flowchart, in accordance with an embodiment of the present invention, showing procedures of address translation from a logical data block address to a physical data block address, as used in the system having limited RAM space.

FIG. 12 is a flowchart, in accordance with an embodiment of the present invention, showing procedures of fetching a requested physical translation page into a second-level cache, as used in the system having limited RAM space.

### DETAILED DESCRIPTION

### A. Basic Idea of the Invention

In Sections C and D below, two address mapping schemes for large-scale NAND flash storage systems are detailed. These two address mapping schemes serve as embodiments of the present invention. For a system with very limited RAM space (e.g., only one or two kilobytes), we disclose an on-demand address mapping scheme that jointly considers both spatial locality and access frequency. For a system with limited RAM space (e.g., less than several megabytes), a demand-based block-level address mapping scheme with a two-level caching mechanism is disclosed for large-scale NAND flash storage systems.

The basic idea of the invention is to store the block-level address mapping table in specific pages (called translation pages) in the flash memory, while designing caches in RAM for storing on-demand block-level address mappings. Since the entire block-level address mapping table is stored in the flash memory, and only the address mappings demanded are loaded into RAM, the RAM footprint can be efficiently reduced.

For the system with limited RAM space, a two-level caching mechanism is designed to improve the cache hit ratio by exploring temporal locality, spatial locality and access frequency together. The first-level cache is used to cache a small number of active block-level mappings. The second-level cache consists two caches to cache translation pages that follow spatial locality and most frequently accessed ones, respectively. A table called translation page mapping table (TPMT) in the RAM is designed as a hub for the two caches in the second-level cache and translation pages in the flash memory. For a given logical block address, if its block-level mapping information cannot be found from the first-level cache, then the logical block address is used as an index of the TPMT to find an entry that contains the physical translation page address (from which the corresponding mapping information can be found in the flash memory). Moreover, in one implementation example, each entry of the TPMT has two flags to represent whether the corresponding physical translation page is cached in one of the two caches in the second-level cache, respectively. The corresponding translation page is read from the flash memory only when it is not cached in the caches of both levels. In such manner, the system response time can be effectively improved. The cache admission protocols and kick-out schemes are designed as well so that spaces of all caches are fully utilized without redundant information and inconsistency.

### B. System Architecture Under Consideration

A NAND flash memory is generally partitioned into blocks where each block is divided into a certain number of pages. One page of a small-block (large-block) NAND flash memory can store 512B (2 KB) data and one small block (large block) consists of 32 (64) pages. Compared with magnetic hard disk storage systems, a NAND flash storage system has two unique characteristics. First, the basic unit for a read operation and a write operation on flash cells is a page, while the basic unit for erase operation is a block, which is referred to as “bulk erase”. Second, the erase operation is required to be done before the write operation, which is referred to as “erase-before-write” or “out-of place update”. These two inherent properties make the management strategy for flash memories more complicated. In order to hide these inherent properties and provide transparent data storage services for file-system users, an FTL is designed.

Typically, an FTL provides three components, which are an address translator, a garbage collector, and a wear-leveler. In an FTL, the address translator maintains an address mapping table, which can be used to translate a logical address to a physical address; a garbage collector reclaims space by erasing obsolete blocks in which there are invalid data; and a wear-leveler is an optional component that distributes erase operations evenly across all blocks, so as to extend the lifetime of the flash memory. The present invention is focused on the management of the address translator in the FTL.

When a file system layer issues a read or a write request with a logical address to a NAND flash memory, the address translator locates the corresponding physical address by searching the address mapping table. This procedure is called address translation. The time cost in this procedure is the address translation overhead. According to the “out-of-place update” property, if a physical address location mapped to a logical address contains previously written data, the input data should be written to an empty physical location in which no data were previously written. The mapping table should then be updated due to the newly-changed address-mapping item.

C. Demand-Based Address Mapping for System with Very Limited RAM Space

### C.1. System Architecture

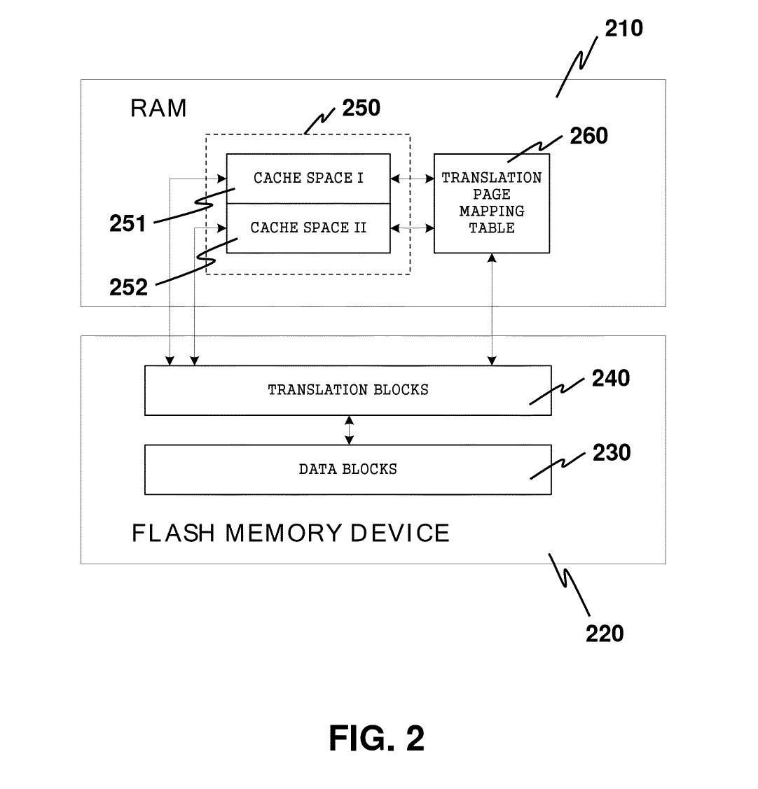

FIG. 2 depicts a schematic overview of demand-based address mapping for a system with very limited memory space. In the architecture shown in FIG. 2, a flash memory 220 stores two kinds of physical blocks: data blocks 230 and translation blocks 240. The data blocks 230, which are designated to store real data from I/O requests, are mapped under a block-level mapping approach. In address mapping, the entire block-level address mapping table is stored in pages of the translation blocks 240. The pages, which are used for storing the block-level address mapping table, are called translation pages. The translation pages in the translation blocks 240 adopt a fine-grained page-level mapping approach. A translation page mapping table (TPMT) 260 for providing physical page addresses in accessing the translation pages resides in RAM 210. A cache space allocation table 250, which also resides in the RAM 210, is used to store on-demand block-level address mappings. In an implementation example shown in FIG. 2, the cache space allocation table 250 is partitioned into Cache Space I 251 and Cache Space II 252.

### C.2. Translation Page Mapping Table 260

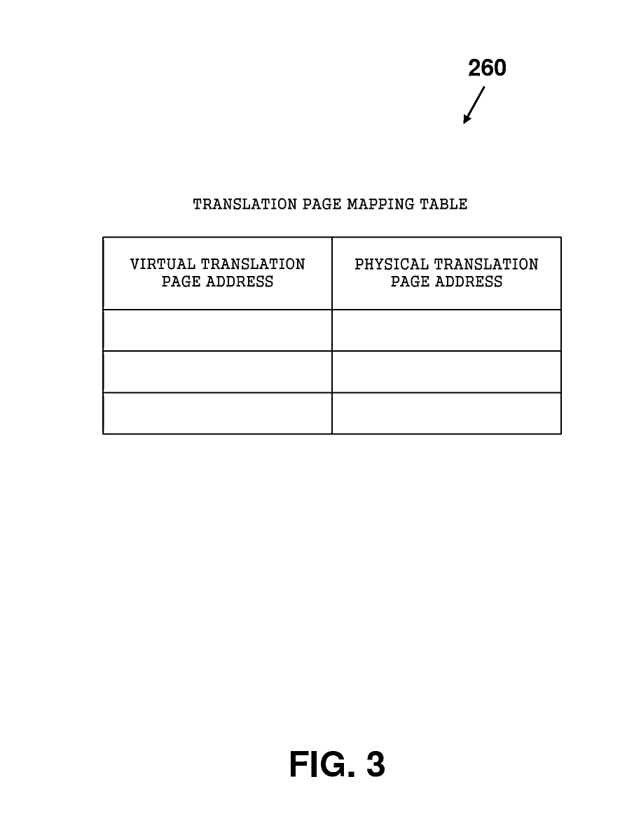

The translation page mapping table 260 is used to store the address mappings between virtual translation page addresses and physical translation page addresses. FIG. 3 illustrates the translation page mapping table 260. The address mapping scheme that is employed adopts a page-level address mapping strategy. The number of items in the mapping table 260 is bounded by the number of translation pages in the translation blocks 240.

### C.3. Cache Space Allocation Table 250

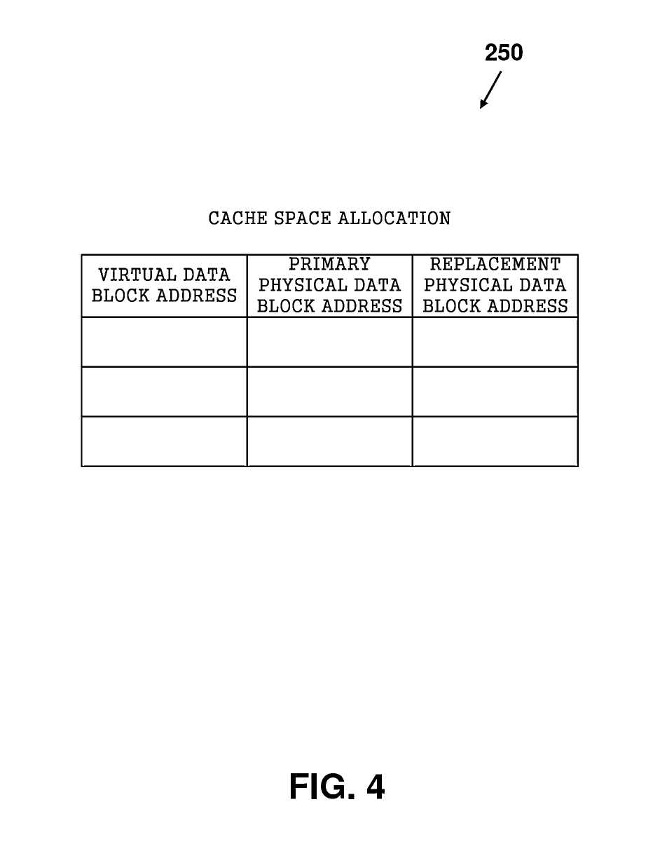

In order to fully utilize the very limited RAM space, the cache space allocation table 250 is used to store active address mappings with the on-demand blocks. FIG. 4 illustrates the mapping items in the cache space allocation table 250. A mapping item records the address mapping of a virtual data block address to a primary physical data block address and a replacement physical data block address.

The cache space allocation table 250 is virtually partitioned into two spaces: Cache Space I 251, and Cache Space II 252. For each cache space, it either stores sequential address mappings or stores random address mappings. The actual space partition between the two cache spaces depends on the application.

### C.4. Address Translation Procedures

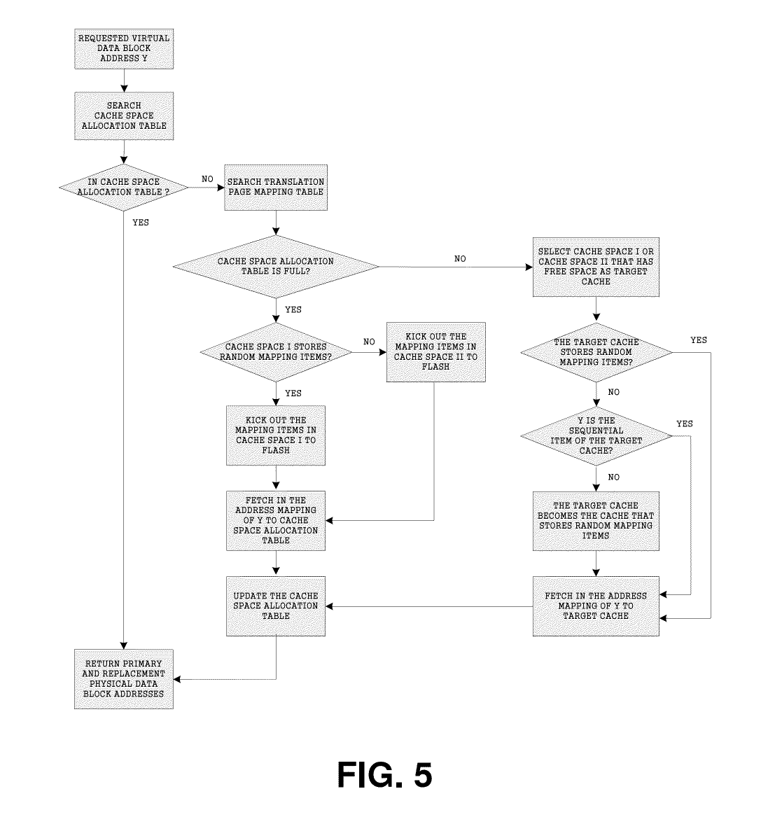

FIG. 5 illustrates the address translation procedures of the demand-based address mapping for the system with very limited RAM space. Given a requested virtual data block address Y, the cache space allocation table is first searched to find if an entry of the requested virtual data block address exists in the cache space allocation table. Since the cache space allocation table only holds a limited number of on-demand address-mapping items, a sequential search may be adopted as it does not incur a long time overhead. If the requested address mapping is in the cache space allocation table, the address mapping item with both the primary and the replacement physical data block addresses are returned. Otherwise, the requested address mapping is determined to be present in the flash memory. In order to find the location that stores the requested address mapping item in the flash memory, the translation page mapping table, which has a record of the physical page address of the requested address mapping, is first consulted. The aforementioned new request of address mapping is the most recently accessed request. To utilize the temporal locality regarding address-mapping requests, it is desirable to store the address mapping of this new request in the cache space allocation table. Therefore, checking whether the cache space allocation table is full is conducted. If the cache space allocation table is full, the address mappings stored in one of the two cache spaces are kicked out. In this regard, whether Cache Space I stores random mapping items is first checked. If it is the case, the address mapping items stored in Cache Space I are kicked out to the flash memory, and thereafter the address mapping of Y are fetched to Cache Space I. If Cache Space I stores sequential mapping items, no matter whether Cache Space II stores sequential mapping items or random mapping items, the mapping items in Cache Space II are kicked out to the flash memory. Then the address mapping of Y can be stored in Cache Space II.

If the cache space allocation table has free space, a cache space (either Cache Space I or Cache Space II) that has free space to hold the new request is first selected. Then this cache space becomes the targeted cache. If the targeted cache stores random mapping items, the address mapping of Y can be directly stored in the targeted cache. If the targeted cache stores sequential mapping items, the address mapping of Y is fetched from the flash memory to the targeted cache, and the targeted cache is re-designated as a cache space that stores random mapping items.

D. Demand-Based Address Mapping for System with Limited RAM Space

### D.1. System Architecture

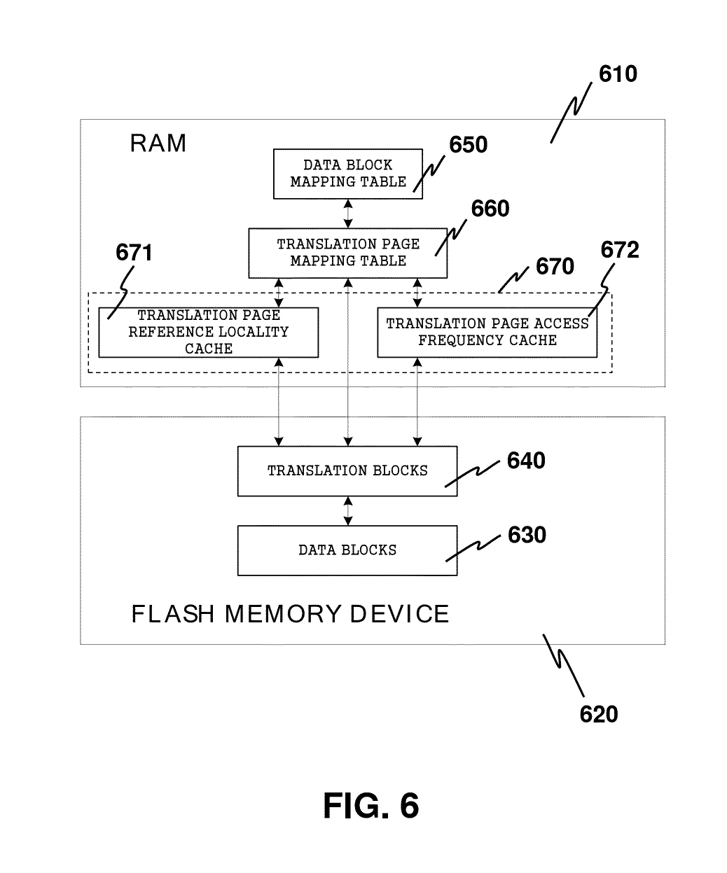

FIG. 6 depicts a schematic overview of demand-based address mapping for a system with limited memory space. In the architecture shown in FIG. 6, a flash memory 620 stores two kinds of physical blocks: data blocks 630 and translation blocks 640. The data blocks 630, which are designated to store real data from I/O requests, are mapped in a block-level mapping approach. Instead of following the traditional method of storing the address mapping table in RAM 610, the entire block-level address mapping table is stored in pages of translation blocks 640. The pages, which are used to store the block-level address mapping table, are called translation pages. The translation pages in the translation blocks 640 adopt the fine-grained page-level mapping approach. A translation page mapping table (TPMT) 660 for providing physical page addresses in accessing the translation pages resides in RAM 610.

The block-level address mapping table for the data blocks 630 is stored in the translation pages, while the page-level address mapping table for the translation pages is stored in the TPMT 660 in the RAM 610. Considering reference locality and access frequency of workloads, we design two levels of caches in the RAM. A data block mapping table cache (DBMTC) 650, which serves as a first-level cache, is used to cache the on-demand data block address mappings. A second-level cache 670 comprises two separate caches, which are a translation page reference locality cache (TPRLC) 671 and a translation page access frequency cache (TPAFC) 672. The TPRLC 671 is used to selectively cache the translation pages that contain the on-demand mappings in the first-level cache, namely the DBMTC 650. The TPAFC 672 is used to cache the translation pages that are frequently accessed after the requested mapping is not found in the DBMTC 650 and the TPRLC 671. The data block address mapping table is cached in the two levels of caches 650, 670 under different caching strategies. A requested address mapping is first searched in the first-level cache (the DBMTC 650). If it is missed, one can get its location-related information by consulting the TPMT 660.

### D.2. Data Blocks 630 and Translation Pages

As mentioned above, the data blocks 630, which are designated to store real data from I/O requests, are mapped in a block-level mapping approach, where one virtual data block address (DVBA) is mapped to one primary physical data block address (DPPBA) and one replacement physical data block address (DRPBA). As is mentioned above, a page in any one of the translation blocks 640 that are used to store the block-level address table is called a translation page. One physical translation page can store a number of logically fixed block-level address mappings. For example, if 8 bytes are needed to represent one address mapping item, it is possible to store 256 logically consecutive mappings in one translation page. Moreover, the space overhead incurred by storing the entire block-level mapping table is negligible when compared to the whole flash space. A 32 GB flash memory needs only about 1.13 MB flash space for storing all mappings.

### D.3. Translation Page Mapping Table (TPMT) 660

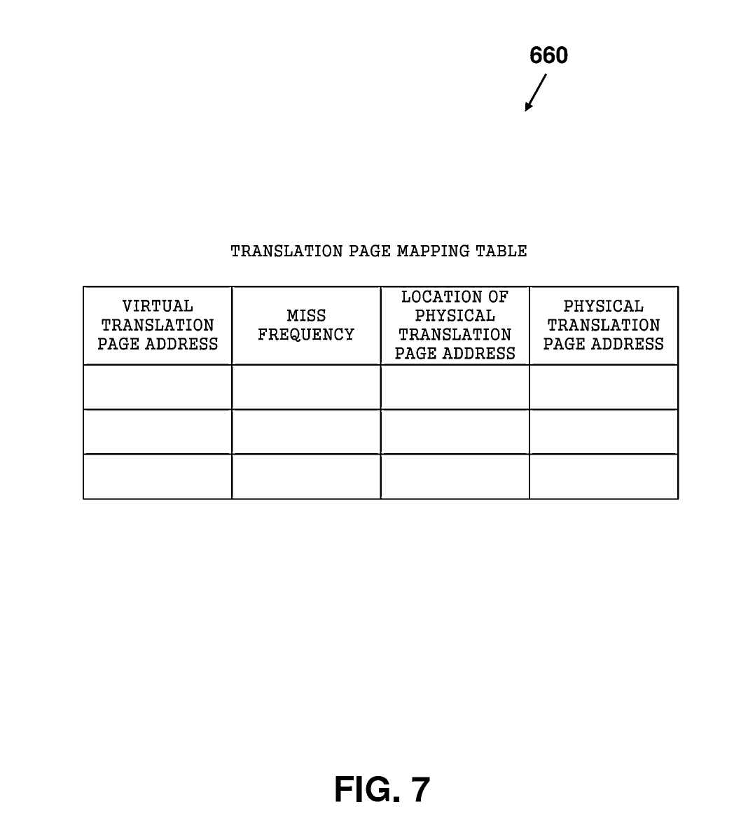

FIG. 7 illustrates the translation page mapping table 660. The translation page mapping table 660 implements address mapping from one virtual translation page address (TVPA) to one physical translation page address (TPPA). Given the requested virtual data block address (DVBA) divided by the number of mappings each physical translation page can store, the quotient is defined as the virtual translation page address (TVPA). Since page-level address mapping is adopted for the translation pages, using the entries in the TPMT 660 enables one to locate the physical translation page that stores the requested virtual data block address immediately. Furthermore, in the TPMT 660, an item “location of physical translation page address” is used to record the location (viz. in the second-level cache 670 or in the flash memory 620) of the physical translation page for each virtual translation page address, thereby eliminating unnecessary effort to read the physical translation page from the flash memory 620 if this physical translation page has been cached in the second-level cache 670. It is preferably and advantageous if the “location indicator” can also point to the specific cache (i.e. the TPRLC 671 or the TPAFC 672) that holds the physical translation page.

In the TPMT 660, another item “miss frequency” is used to record an access frequency of each virtual translation page address when the requested mapping is missed in the first-level cache (the DBMTC 650) and the TPRLC 671. The value of “miss frequency” is required to be increased by one if the requested mapping is missed in the first two caches, i.e. the DBMTC 650 and the TPRLC 671. It follows that the accumulated value of “miss frequency” indicates the number of times of fetching the corresponding translation page from the flash memory 620 to the RAM 610. Although the TPMT 660 is maintained in the RAM 610 without any footprint in the flash memory 620, it does not introduce a lot of space overhead. For example, a 32 GB flash storage requires only 1024 translation pages, which occupy only about 4 KB of the RAM space.

### D.4. Data Block Mapping Table Cache (DBMTC) 650

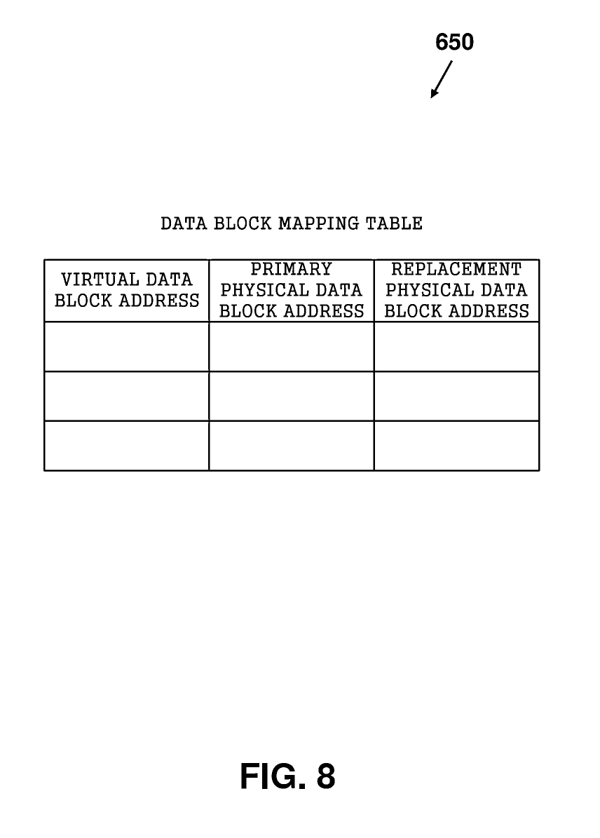

Making use of temporal locality in workloads, we design the DBMTC 650 in the RAM 610 to cache a small number of active mappings associated with the on-demand blocks. FIG. 8 illustrates the DBMTC 650. The requested mapping is searched and updated in the RAM 610 rather than in the translation pages in that updating the former reduces the address translation overhead. If the requested mapping is not stored in the cache while the cache is not full, the requested mapping will be fetched into the cache directly once it is retrieved from the physical translation pages. If the cache is full, one victim mapping slot is required to be kicked out in order to make room for the new fetched-in mapping slot. It may lead to extra translation-page copy operations. In order to avoid such extra overhead, the selection of a victim translation page and the fetch-in operation are performed as follows: amongst all mapping slots in the DBMTC 650, if a mapping is also currently included in the second-level cache 670, such mapping can be selected as the victim; if one mapping slot has not been updated since it was fetched into the cache, it can be selected as the victim; otherwise, no victim is required and no fetch-in operation is performed for the first-level cache (i.e. the DBMTC 650). As the first-level cache is in the RAM, the DBMTC 650 can be set to different sizes in a flexible manner according the size of the address-mapping table required to be cached. For example, the size of the DBMTC 650 may be set to 16 KB, which is only about 1% of the whole mapping-table size (1.13 MB). If one mapping takes up 8 bytes, then 2048 entries are included in the DBMTC 650. When the active mapping set is large, we adopt a four-way set associative mapping approach for cache organization.

### D.5. Translation Page Reference Locality Cache (TPRLC) 671

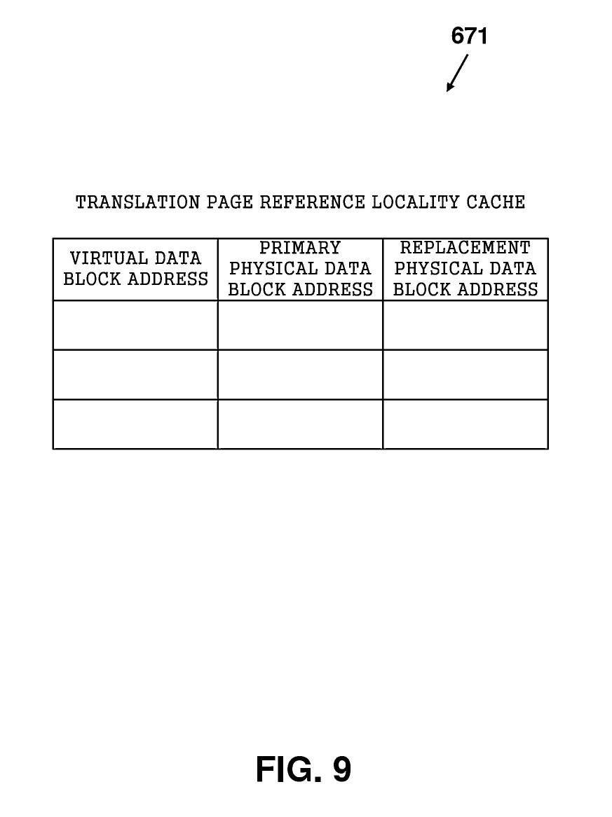

The translation page for storing the on-demand mapping slot that has just been missed in the first-level cache (the DBMTC 650) is selectively cached in the TPRLC 671. FIG. 9 illustrates the TPRLC 671. Since the translation page covers a wider spectrum of logically consecutive address mappings, according to spatial locality in workloads, it is possible that a request is hit in the TPRLC 671 after it is missed in the first-level cache. When the requested mapping is missed in the first-level cache, no fetch-in operation is performed if no victim is selected based on the cost-benefit analysis for the first-level cache. In this situation, the requested mapping can still be cached in the RAM 610 as its corresponding translation page will be fetched into the TPRLC 671 from the flash memory 620. As one part of the second-level cache 670, the fetch-in operation for the TPRLC 671 is invoked by the fetch-in operation performed for the first-level cache. When the TPRLC 671 is full, one victim page is to be kicked out in order to make room for the forthcoming fetched-in translation page. Least recently used (LRU) algorithm is adopted as the replacement algorithm for TPRLC 671.

### D.6. Translation Page Access Frequency Cache (TPAFC) 672

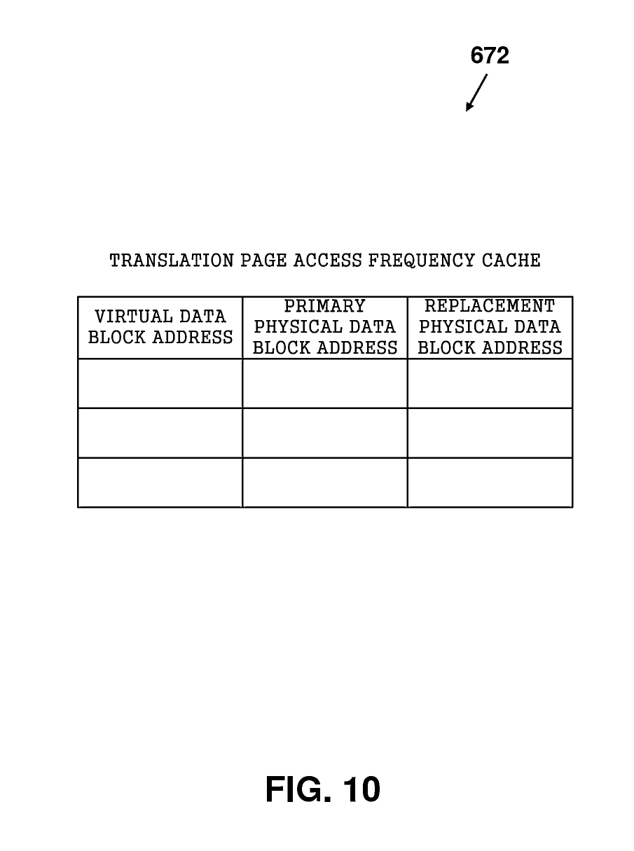

The translation page that shows the strongest tendency of being fetched into the RAM 610 is selectively cached in the TPAFC 672. FIG. 10 illustrates the TPAFC 672. When the requested mapping is frequently missed in the first-level cache (the DBMTC 650) and the TPRLC 671, it is desirable to be fetched into the RAM 610 from the flash memory 620 in order to reduce the address translation overhead. As another part of the second-level cache 670, the TPAFC 672 is designed to cache the translation pages containing frequently requested mappings. In this manner, the requested mapping that is missed in the DBMTC 650 and the TPRLC 671 may be hit in this cache. Least frequently used (LFU) replacement algorithm is used to evict the victim translation page when the cache is full. The fetch-in operation is performed when one translation page in the flash memory 620 shows a higher access frequency when compared to a cached translation page having the lowest access frequency.

The size of the second-level cache 670 (the TPRLC 671 and the TPAFC 672 altogether) can be flexibly tuned against the RAM-size constraint. For example, 10 translation pages take up about 20 KB RAM space. Since the virtual translation page address is cached as the index in the second-level cache 670, sequential lookup is sufficient to search logically consecutive address mappings stored therein.

### D.7. Logical to Physical Address Translation

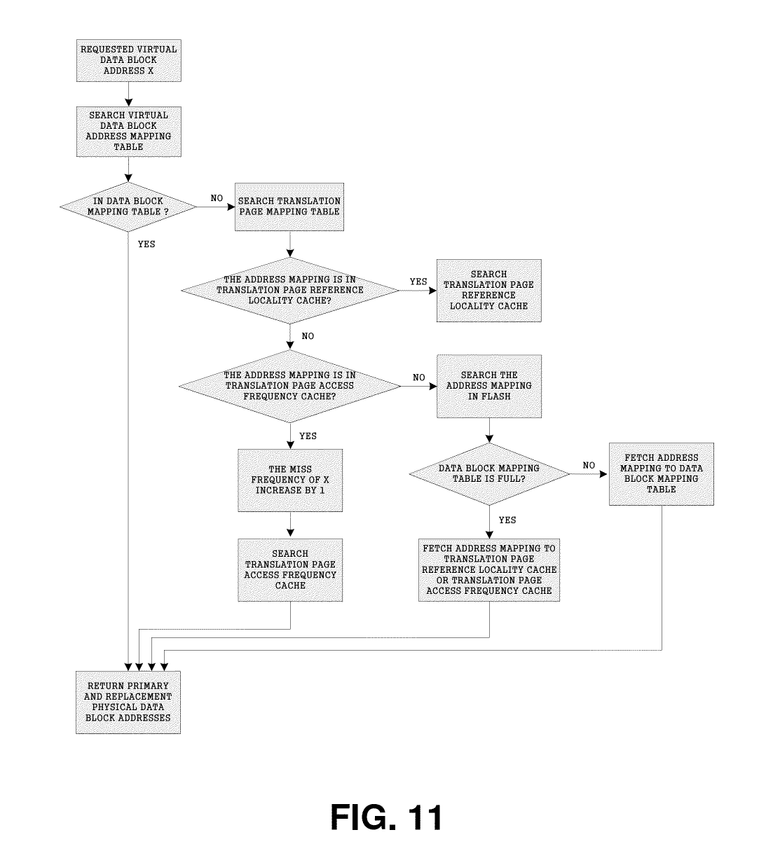

A requested address mapping is first searched in the two levels of caches (the DBMTC 650, the TPRLC 671 and the TPAFC 672), and is then retrieved from one of the translation pages if it is missed in the caches. FIG. 11 depicts a procedure of address translation from a logical data block address to a physical data block address.

If the requested mapping is hit at the first-level cache (i.e. the DBMTC 650), one can directly obtained this requested mapping. Otherwise, one is required to consult the TPMT 660 for the location of the translation page that contains the requested mapping. If the requested mapping is cached in the second-level cache 670, one can find it by sequentially searching the second-level cache 670. If both levels of caches (i.e. the DBMTC 650, the TPRLC 671 and the TPAFC 672) miss the requested mapping and are full, the requested mapping slot will be fetched into the first-level cache (the DBMTC 650), and the requested translation page will also be fetched into the TPRLC 671 or the TPAFC 672.

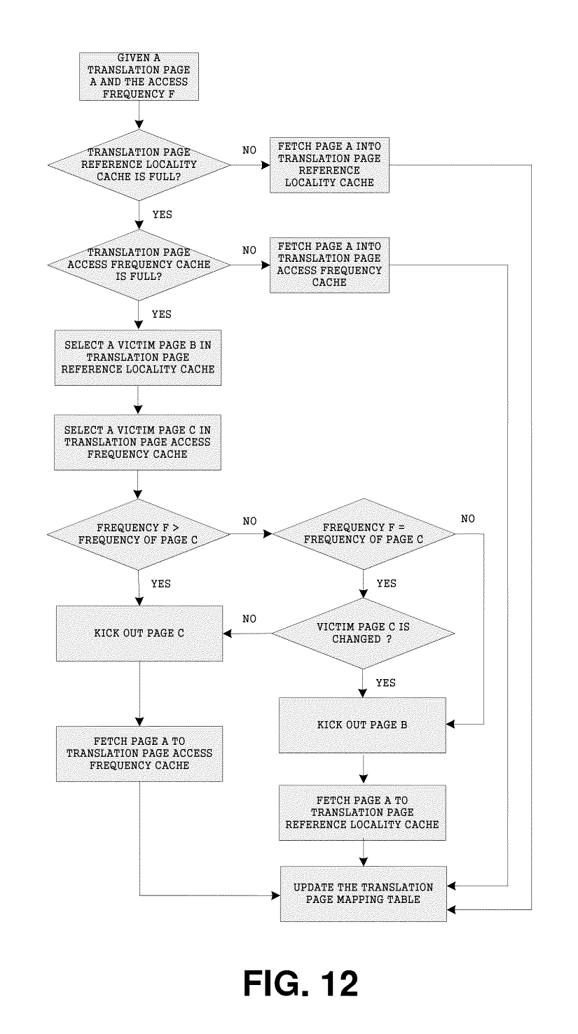

FIG. 12 depicts a procedure of fetching the requested physical translation page into the second-level cache 670. After the requested mapping is fetched into the DBMTC 650, the corresponding translation page should also be loaded into the second-level cache 670. If both the TPRLC 671 and the TPAFC 672 are full, victim translation pages are selected from the TPRLC 671 and the TPAFC 672 according to the LRU replacement algorithm and the LFU replacement algorithm, respectively. If the access frequency of the requested translation page is higher than that of the victim page in the TPAFC 672, the requested translation page will be fetched into the TPAFC 672 after kicking out the victim page therein. If the requested page in the flash memory 620 and the victim page in the TPAFC 672 have the same access frequencies, the fetch-in operation is performed based on a simple cost-benefit analysis as follows. The victim page that is not changed since it was fetched into the TPAFC 670 will be kicked out, and the requested translation page will then be fetched-in; otherwise, the requested translation page will be fetched into the TPRLC 671. When the access frequency of the requested page is lower than that of the victim page in the TPAFC 672, the requested page will be fetched into the TPRLC 671 after performing a kick-out operation for the TPRLC 671.

### H. The Present Invention

This invention provides a first method and a second method for implementing an FTL in a computer subsystem that comprises a flash memory and a RAM. The flash memory is arranged in blocks each of which comprises a number of pages and is addressable according to a physical block address. Each of the pages in any one of the blocks is addressable by a physical page address.

In the implementation of the FTL, most often one or more processors are involved for controlling activities performed by or for the FTL. The one or more processors may include a general processor with program and data memories, a flash-memory controller for controlling and read-write-erase accessing the flash memory, or a communication-interfacing processor for interfacing the computer subsystem with the environment outside the subsystem. It is possible to incorporate the one or more processors in the computer subsystem that is considered herein. The one or more processors can be configured to execute a process according to either the first method or the second method disclosed herein for implementing the FTL in the computer subsystem.

The first and the second methods disclosed herein are advantageously applicable to a NAND flash memory. However, the present invention is not limited only to the NAND flash memory. The present invention is applicable to a general flash memory that supports page-wise read/write and that is arranged in blocks each of which is further arranged as a plurality of pages.

The first method disclosed herein, elaborated as follows, is based on the disclosure in Section C above. Preferably, the first method is advantageously used for implementing the FTL in the presence of RAM space that is very limited.

In the first method, a first number of the blocks in the flash memory are allocated as data blocks for storing real data, and a second number of the blocks other than the data blocks are allocated as translation blocks. In particular, an entirety of the translation blocks is configured to store a block-level mapping table comprising first address-mapping data structures. Each of the first address-mapping structures includes (1) a logical block address of one of the data blocks and (2) a physical block address that corresponds to the logical block address of the one of the data blocks. As is mentioned above, a page of any of the translation blocks is regarded as a translation page.

Furthermore, a first part of the RAM is allocated as a cache space allocation table configured to comprise second address-mapping data structures. Each of the second address-mapping data structures either is marked as available, or includes (1) a logical block address of a selected one of the data blocks and (2) a physical block address that corresponds to the logical block address of the selected one of the data blocks. In addition, a second part of the RAM is allocated as a translation page mapping table configured to comprise third address-mapping data structures. Each of the third address-mapping data structures includes (1) a logical block address of a selected one of the data blocks, and (2) a physical page address of a translation page that stores the physical block address corresponding to the logical block address of the selected one of the data blocks.

When an address-translating request is received, a requested virtual data block address is translated to a physical block address corresponding thereto by an address-translating process.

In the address-translating process, the cache space allocation table is searched in order to identify, if any, a first-identified data structure where the logical block address in the first-identified data structure matches the requested virtual data block address. Preferably, as is explained in Section C.4, a sequential search strategy is adopted in searching the cache space allocation table. Note that the first-identified data structure is selected from among the second address-mapping data structures in the cache space allocation table. If the first-identified data structure is identified, the physical block address in the first-identified data structure is assigned as the physical block address corresponding to the requested virtual data block address. Otherwise, the translation blocks in the flash memory are searched in order to identify a second-identified data structure where the logical block address in the second-identified data structure matches the requested virtual data block address. The second-identified data structure is selected from among the first address-mapping data structures in the translation blocks. The translation blocks and also the translation pages therein are accessed according to the physical page addresses provided by the translation page mapping table. When the second-identified data structure is identified, the physical block address in the second-identified data structure is assigned as the physical block address corresponding to the requested virtual data block address. Furthermore, the cache space allocation table is updated with the second-identified data structure by a cache-updating process. The cache-updating process includes copying the second-identified data structure onto a targeted second address-mapping data structure selected from among the second address-mapping data structures.

In the first method disclosed herein, preferably the cache space allocation table is partitioned into a third number of cache spaces. In the presence of such partitioning, the cache-updating process further includes the following actions. If the cache space allocation table is not full, one of the second address-mapping data structures marked as available is selected as the targeted second address-mapping data structure. In case the cache space allocation table is full, one of the cache spaces is selected as a first chosen cache space. Any one of the second address-mapping data structures in the first chosen cache space is then selected as the targeted second address-mapping data structure, onto which the second-identified data structure is to be copied. Furthermore, all the second address-mapping data structures in the first chosen cache space except the targeted second address-mapping data structure are marked as available.

In one embodiment, the third number mentioned above for partitioning the cache space allocation table is two. As an example, partitioning into two cache spaces is also mentioned in the disclosure of Section C.3 above. It follows that the cache space allocation table is partitioned into a first cache space and a second cache space. Consider a situation that the cache space allocation table is full. If the first cache space is designated for storing random mapping items, the first cache space is selected to be the first chosen cache space, onto which the second-identified data structure is copied. If, on the other hand, the first cache space is designated for storing sequential items rather than random mapping items, the second cache space is selected to be the first chosen cache space. Consider another situation that the cache space allocation table is not full. In this situation, a cache space (either the first cache space or the second cache space) that contains the targeted second address-mapping data structure is referred to as a second chosen cache space. The cache-updating process further includes: if the second chosen cache space is not designated for storing random mapping items and if the second-identified data structure is not a sequential item in the second chosen cache space, re-designating the second chosen cache space as a cache space for storing random mapping items.

In one embodiment, also mentioned in Section C.3, it is desired to map a virtual data block address to a primary physical data block address and a replacement physical data block address. It follows that, in any one of the first and the second address-mapping data structures, the logical block address therein is regarded as a virtual data block address and the physical block address therein is regarded as a primary physical data address. Any one of the first address-mapping data structures may further include a replacement physical data block address corresponding to the logical block address therein. Similarly, any one of the second address-mapping data structures, if not marked as available, may further include a replacement physical data block address corresponding to the logical block address therein. With such arrangement, both the primary physical block address and the replacement physical data block address can be obtained for the requested virtual data block address after the address-translating request is received.

The second method disclosed herein, elaborated as follows, is based on the disclosure in Section D above. Preferably, the second method is advantageously used for implementing the FTL in the presence of RAM space that is moderately limited.

In the second method, a first number of the blocks in the flash memory are allocated as data blocks for storing real data, and a second number of the blocks other than the data blocks are allocated as translation blocks. An entirety of the translation blocks is configured to store a block-level mapping table comprising first address-mapping data structures. Each of the first address-mapping structures includes (1) a logical block address of one of the data blocks and (2) a physical block address that corresponds to the logical block address of the one of the data blocks.

A first part of the RAM is allocated as a data block mapping table cache (DBMTC) configured to comprise second address-mapping data structures. Each of the second address-mapping data structures either is marked as available, or includes (1) a logical block address of a selected one of the data blocks and (2) a physical block address that corresponds to the logical block address of the selected one of the data blocks.

A second part of the RAM is allocated as a translation page mapping table (TPMT) configured to comprise third address-mapping data structures. Each of the third address-mapping data structures includes (1) a logical block address of a selected one of the data blocks, (2) a physical page address of a translation page that stores the physical block address corresponding to the logical block address of the selected one of the data blocks, (3) a location indicator for indicating a positive result or a negative result on whether a copy of the aforesaid translation page is cached in the RAM, and (4) a miss-frequency record.

A third part of the RAM is allocated as a translation page reference locality cache (TPRLC) configured to comprise fourth address-mapping data structures. Each of the fourth address-mapping data structures either is marked as available, or includes (1) a logical block address of a selected one of the data blocks and (2) a physical block address that corresponds to the logical block address of the selected one of the data blocks.

A fourth part of the RAM is allocated as a translation page access frequency cache (TPAFC) configured to comprise fifth address-mapping data structures. Each of the fifth address-mapping data structures either is marked as available, or includes (1) a logical block address of a selected one of the data blocks and (2) a physical block address that corresponds to the logical block address of the selected one of the data blocks.

Optionally and advantageously, the location indicator may include a first flag for indicating whether the copy of translation page is currently cached in the TPRLC, and a second flag for indicating whether this copy is currently cached in the TPAFC.

When an address-translating request is received, a requested virtual data block address is translated to a physical block address corresponding thereto by an address-translating process.

In the address-translating process, the DBMTC is searched in order to identify, if any, a first-identified data structure where the logical block address in the first-identified data structure matches the requested virtual data block address. Note that the first-identified data structure is selected from among the second address-mapping data structures. If the first-identified data structure is identified, the physical block address in the first-identified data structure is assigned as the physical block address corresponding to the requested virtual data block address. Otherwise, the TPMT is searched in order to identify a second-identified data structure where the logical block address in the second-identified data structure matches the requested virtual data block address. Similarly, the second-identified data structure is selected from among the third address-mapping data structures. If the location indicator in the second-identified data structure indicates the positive result, it implies that a copy of translation page containing an address-mapping item relevant to the address-translating request is present in the RAM. Then the TPRLC and the TPAFC are searched in order to identify a third-identified data structure selected from among the fourth and the fifth address-mapping data structures such that the logical block address in the third-identified data structure matches the requested virtual data block address. Preferably, as is indicated in Section D.7, a sequential search strategy is adopted in searching the TPRLC and the TPAFC. If the third-identified data structure is identified in the TPAFC, the miss-frequency record in the second-identified data structure is increased by one. When the third-identified data structure is identified, the physical block address in the third-identified data structure is assigned as the physical block address corresponding to the requested virtual data block address. On the other hand, if the location indicator in the second-identified data structure indicates the negative result, an entirety of the translation page having the physical page address stored in the second-identified data structure is loaded from the flash memory to the RAM. (This entire translation page will be used to update either the TPRLC or the TPAFC.) The loaded translation page is then searched in order to identify a fourth-identified data structure where the logical block address in the fourth-identified data structure matches the requested virtual data block address. When the fourth-identified data structure is identified, the physical block address in the fourth-identified data structure is assigned as the physical block address corresponding to the requested virtual data block address. The DBMTC is also updated with the fourth-identified data structure. Furthermore, either TPRLC or the TPAFC is updated with the loaded translation page by a cache-updating process, and the location indicator in the second-identified data structure is updated with the positive result.

Optionally, the cache-updating process is characterized by the following. If any one of the TPRLC and the TPAFC is not full, the loaded translation page is stored into a targeted cache (either the TPRLC or the TPAFC) that is not full. If both the TPRLC and the TPAFC are full, the following actions are performed.
A first victim translation page is selected from the TPRLC. The miss-frequency record in a fifth-identified data structure is retrieved, wherein the fifth-identified data structure is selected from among the third address-mapping data structures, and has the physical page address therein matched with a physical page address of the first victim translation page.
A second victim translation page is selected from the TPAFC. The miss-frequency record in a sixth-identified data structure is retrieved, wherein the sixth-identified data structure is selected from among the third address-mapping data structures, and has the physical page address therein matched with a physical page address of the second victim translation page.
A targeted victim translation page is selected from the first and the second victim translation pages according to the miss-frequency records in the fifth-identified data structure and in the sixth-identified data structure.
The loaded translation page is written onto the targeted victim translation page.
   An example of the cache-updating process is given in Section D.7. Preferably, the first victim translation page is selected from among translation pages present in the TPRLC according to the LRU algorithm. It is also preferable that the second victim translation page is selected from among translation pages present in the TPAFC according to the LFU algorithm.

In one embodiment, also mentioned in Section D.2, it is desired to map a virtual data block address to a primary physical data block address and a replacement physical data block address. It follows that, in any one of the first, the second, the fourth and the fifth address-mapping data structures, the logical block address therein is regarded as a virtual data block address and the physical block address therein is regarded as a primary physical data address. Any one of the first address-mapping data structures may further include a replacement physical data block address corresponding to the logical block address therein. Similarly, any one of the second, the fourth and the fifth address-mapping data structures, if not marked as available, may further include a replacement physical data block address corresponding to the logical block address therein. With such arrangement, both the primary physical block address and the replacement physical data block address can be obtained for the requested virtual data block address after the address-translating request is received.

The present invention may be embodied in other specific forms without departing from the spirit or essential characteristics thereof. The present embodiment is therefore to be considered in all respects as illustrative and not restrictive. The scope of the invention is indicated by the appended claims rather than by the foregoing description, and all changes that come within the meaning and range of equivalency of the claims are therefore intended to be embraced therein.

What is claimed is:

1. A method for implementing a flash translation layer in a computer subsystem that comprises a flash memory and a random access memory (RAM), the flash memory being arranged in blocks each of which comprises a number of pages and is addressable according to a physical block address, each of the pages in any one of the blocks being addressable by a physical page address, the method comprising:
allocating a first number of the blocks as data blocks for storing real data;
allocating a second number of the blocks other than the data blocks as translation blocks, a page of any of the translation blocks being regarded as a translation page, wherein an entirety of the translation blocks is configured to store a block-level mapping table comprising first address-mapping data structures each of which includes a logical block address of one of the data blocks and a physical block address that corresponds to the logical block address of the one of the data blocks;
allocating a first part of the RAM as a cache space allocation table configured to comprise second address-mapping data structures each of which either is marked as available, or includes a logical block address of a selected one of the data blocks and a physical block address that corresponds to the logical block address of the selected one of the data blocks;
allocating a second part of the RAM as a translation page mapping table configured to comprise third address-mapping data structures each of which includes a logical block address of a selected one of the data blocks, and a physical page address of a translation page that stores the physical block address corresponding to the logical block address of the selected one of the data blocks; and
when an address-translating request is received, translating a requested virtual data block address to a physical block address corresponding thereto by an address-translating process;
wherein the address-translating process comprises:
searching the cache space allocation table for identifying, if any, a first-identified data structure selected from among the second address-mapping data structures where the logical block address in the first-identified data structure matches the requested virtual data block address;
if the first-identified data structure is identified, assigning the physical block address in the first-identified data structure as the physical block address corresponding to the requested virtual data block address;
if the first-identified data structure is not identified, searching the translation blocks for identifying a second-identified data structure selected from among the first address-mapping data structures where the logical block address in the second-identified data structure matches the requested virtual data block address, wherein the translation page mapping table provides the physical page addresses stored therein for accessing the translation blocks;
when the second-identified data structure is identified, assigning the physical block address in the second-identified data structure as the physical block address corresponding to the requested virtual data block address; and
when the second-identified data structure is identified, updating the cache space allocation table with the second-identified data structure by a cache-updating process, wherein the cache-updating process includes copying the second-identified data structure onto a targeted second address-mapping data structure selected from among the second address-mapping data structures.

2. The method of claim 1, wherein the cache space allocation table is partitioned into a third number of cache spaces, and wherein the cache-updating process further includes:
if the cache space allocation table is not full, selecting one of the second address-mapping data structures marked as available as the targeted second address-mapping data structure; and
if the cache space allocation table is full, selecting one of the cache spaces as a first chosen cache space, selecting any one of the second address-mapping data structures in the first chosen cache space as the targeted second address-mapping data structure, and marking as available all the second address-mapping data structures in the first chosen cache space except the targeted second address-mapping data structure.

3. The method of claim 2, wherein:
the third number is two so that the cache space allocation table is partitioned into a first cache space and a second cache space;
if the cache space allocation table is full and if the first cache space is designated for storing random mapping items, the first cache space is selected to be the first chosen cache space;
if the cache space allocation table is full and if the first cache space is not designated for storing random mapping items, the second cache space is selected to be the first chosen cache space; and
the cache-updating process further includes:
(a) for a second chosen cache space that is either the first cache space or the second cache space and that is identified to contain the targeted second address-mapping data structure selected when the cache space allocation table is not full, if the second chosen cache space is not designated for storing random mapping items and if the second-identified data structure is not a sequential item in the second chosen cache space, re-designating the second chosen cache space as a cache space for storing random mapping items.

4. The method of claim 1, wherein:
any one of the first address-mapping data structures further includes a replacement physical data block address corresponding to the logical block address therein while the logical block address therein is regarded as a virtual data block address and the physical block address therein is regarded as a primary physical data address; and
any one of the second address-mapping data structures, if not marked as available, further includes a replacement physical data block address corresponding to the logical block address therein while the logical block address therein is regarded as a virtual data block address and the physical block address therein is regarded as a primary physical data address;
thereby allowing the primary physical block address and the replacement physical data block address, both corresponding to the requested virtual data block address, to be obtained after the address-translating request is received.

5. The method of claim 1, wherein a sequential search is conducted in the searching of the cache space allocation table for identifying the first-identified data structure.

6. The method of claim 1, wherein the flash memory is a NAND flash memory.

7. A computer subsystem comprising a flash memory, a RAM and one or more processors, wherein the one or more processors are configured to execute a process for implementing a flash translation layer according to the method of claim 1.

8. A computer subsystem comprising a flash memory, a RAM and one or more processors, wherein the one or more processors are configured to execute a process for implementing a flash translation layer according to the method of claim 2.

9. A computer subsystem comprising a flash memory, a RAM and one or more processors, wherein the one or more processors are configured to execute a process for implementing a flash translation layer according to the method of claim 3.

10. A computer subsystem comprising a flash memory, a RAM and one or more processors, wherein the one or more processors are configured to execute a process for implementing a flash translation layer according to the method of claim 4.

11. A method for implementing a flash translation layer in a computer subsystem that comprises a flash memory and a random access memory (RAM), the flash memory being arranged in blocks each of which comprises a number of pages and is addressable according to a physical block address, each of the pages in any one of the blocks being addressable by a physical page address, the method comprising:
allocating a first number of the blocks as data blocks for storing real data;
allocating a second number of the blocks other than the data blocks as translation blocks, a page of any of the translation blocks being regarded as a translation page, wherein an entirety of the translation blocks is configured to store a block-level mapping table comprising first address-mapping data structures each of which includes a logical block address of one of the data blocks and a physical block address that corresponds to the logical block address of the one of the data blocks;
allocating a first part of the RAM as a data block mapping table cache (DBMTC) configured to comprise second address-mapping data structures each of which either is marked as available, or includes a logical block address of a selected one of the data blocks and a physical block address that corresponds to the logical block address of the selected one of the data blocks;
allocating a second part of the RAM as a translation page mapping table (TPMT) configured to comprise third address-mapping data structures each of which includes a logical block address of a selected one of the data blocks, a physical page address of a translation page that stores the physical block address corresponding to the logical block address of the selected one of the data blocks, a location indicator for indicating a positive result or a negative result on whether a copy of the aforesaid translation page is cached in the RAM, and a miss-frequency record;
allocating a third part of the RAM as a translation page reference locality cache (TPRLC) configured to comprise fourth address-mapping data structures each of which either is marked as available, or includes a logical block address of a selected one of the data blocks and a physical block address that corresponds to the logical block address of the selected one of the data blocks;
allocating a fourth part of the RAM as a translation page access frequency cache (TPAFC) configured to comprise fifth address-mapping data structures each of which either is marked as available, or includes a logical block address of a selected one of the data blocks and a physical block address that corresponds to the logical block address of the selected one of the data blocks;
when an address-translating request is received, translating a requested virtual data block address to a physical block address corresponding thereto by an address-translating process;
wherein the address-translating process comprises:
searching the DBMTC for identifying, if any, a first-identified data structure selected from among the second address-mapping data structures where the logical block address in the first-identified data structure matches the requested virtual data block address;
if the first-identified data structure is identified, assigning the physical block address in the first-identified data structure as the physical block address corresponding to the requested virtual data block address;
if the first-identified data structure is not identified, searching the TPMT for identifying a second-identified data structure among the third address-mapping data structures where the logical block address in the second-identified data structure matches the requested virtual data block address;
if the location indicator in the second-identified data structure indicates the positive result, searching the TPRLC and the TPAFC for a third-identified data structure selected from among the fourth and the fifth address-mapping data structures where the logical block address in the third-identified data structure matches the requested virtual data block address;
if the third-identified data structure is identified in the TPAFC, increasing the miss-frequency record in the second-identified data structure by one;
when the third-identified data structure is identified, assigning the physical block address in the third-identified data structure as the physical block address corresponding to the requested virtual data block address;
if the location indicator in the second-identified data structure indicates the negative result, loading an entirety of the translation page having the physical page address stored in the second-identified data structure from the flash memory to the RAM, and searching the loaded translation page for identifying a fourth-identified data structure in the loaded translation page where the logical block address in the fourth-identified data structure matches the requested virtual data block address;
when the fourth-identified data structure is identified, assigning the physical block address in the fourth-identified data structure as the physical block address corresponding to the requested virtual data block address;
when the fourth-identified data structure is identified, updating the DBMTC with the fourth-identified data structure; and
when the fourth-identified data structure is identified, updating either the TPRLC or the TPAFC with the loaded translation page by a cache-updating process, and updating the location indicator in the second-identified data structure with the positive result.

12. The method of claim 11, wherein the cache-updating process comprises:
if any one of the TPRLC and the TPAFC is not full, storing the loaded translation page into a targeted cache that is selected from the TPRLC and the TPAFC and that is not full; and
if both the TPRLC and the TPAFC are full, performing:
(a) selecting a first victim translation page from the TPRLC, and retrieving the miss-frequency record in a fifth-identified data structure selected from among the third address-mapping data structures where the fifth-identified data structure has the physical page address therein matched with a physical page address of the first victim translation page;
(b) selecting a second victim translation page from the TPAFC, and retrieving the miss-frequency record in a sixth-identified data structure selected from among the third address-mapping data structures where the sixth-identified data structure has the physical page address therein matched with a physical page address of the second victim translation page;
(c) selecting a targeted victim translation page from the first and the second victim translation pages according to the miss-frequency records in the fifth-identified data structure and in the sixth-identified data structure; and
(d) overwriting the loaded translation page onto the targeted victim translation page.

13. The method of claim 12, wherein:
the first victim translation page is selected from among translation pages present in the TPRLC according to Least recently used (LRU) algorithm; and
the second victim translation page is selected from among translation pages present in the TPAFC according to Least frequently used (LFU) algorithm.

14. The method of claim 11, wherein:
any one of the first address-mapping data structures further includes a replacement physical data block address corresponding to the logical block address therein while the logical block address therein is regarded as a virtual data block address and the physical block address therein is regarded as a primary physical data address;
any one of the second address-mapping data structures, if not marked as available, further includes a replacement physical data block address corresponding to the logical block address therein while the logical block address therein is regarded as a virtual data block address and the physical block address therein is regarded as a primary physical data address;
any one of the fourth address-mapping data structures, if not marked as available, further includes a replacement physical data block address corresponding to the logical block address therein while the logical block address therein is regarded as a virtual data block address and the physical block address therein is regarded as a primary physical data address; and
any one of the fifth address-mapping data structures, if not marked as available, further includes a replacement physical data block address corresponding to the logical block address therein while the logical block address therein is regarded as a virtual data block address and the physical block address therein is regarded as a primary physical data address;
thereby allowing the primary physical block address and the replacement physical data block address, both corresponding to the requested virtual data block address, to be obtained after the address-translating request is received.

15. The method of claim 11, wherein a sequential search is conducted in the searching of the TPRLC and the TPAFC for a third-identified data structure.

16. The method of claim 11, wherein the flash memory is a NAND flash memory.

17. A computer subsystem comprising a flash memory, a RAM and one or more processors, wherein the one or more processors are configured to execute a process for implementing a flash translation layer according to the method of claim 11.

18. A computer subsystem comprising a flash memory, a RAM and one or more processors, wherein the one or more processors are configured to execute a process for implementing a flash translation layer according to the method of claim 12.

19. A computer subsystem comprising a flash memory, a RAM and one or more processors, wherein the one or more processors are configured to execute a process for implementing a flash translation layer according to the method of claim 13.

20. A computer subsystem comprising a flash memory, a RAM and one or more processors, wherein the one or more processors are configured to execute a process for implementing a flash translation layer according to the method of claim 14.
